(19) United States
(12) Patent Application Publication
(10) Pub. No.: US 2024/0409035 A1
(43) Pub. Date: Dec. 12, 2024

(54) SUPPORT DEVICE

(71) Applicant: The Dynamic Engineering Solution Pty Ltd, Holden Hill, South Australia (AU)

(72) Inventor: Andrew Collins, Holden Hill, South Australia (AU)

(21) Appl. No.: 18/694,971

(22) PCT Filed: Sep. 21, 2022
(86) PCT No.: PCT/AU2022/051142

§ 371 Date: Mar. 23, 2024

(30) Foreign Application Priority Data
Sep. 24, 2021 (AU) 2021903077

(51) Int. Cl. B60R 9/00

(52) U.S. Cl. CPC B60R 9/00

(57) ABSTRACT

A support device for facilitating the loading of a container on a vehicle. the support device comprising a front arm and a rear arm, comprising corresponding front and rear support surfaces for the container, the front and rear arms being pivotally connected to one another about a first axis, and pivotally moveable relative to one another between a stowed configuration and a deployed configuration, wherein pivotal movement of the front and rear arms relative to one another is achieved by way of an actuator acting on intermediate portions of both the front and rear arms, where from a stowed configuration, extension of the actuator moves the front and rear arms toward their deployed configuration, and where from the deployed configuration, retraction of the actuator moves the front and rear arms toward their stowed configuration. the support device further comprising a latching arrangement for securing the front and rear arms in their deployed configuration.

### PRIORITY DOCUMENTS

The present application claims priority from Australian Provisional Patent Application No. 2021903077 titled SUPPORT DEVICE and filed on 24 Sep. 2021, the content of which is hereby incorporate by reference in its entirety.

### TECHNICAL FIELD

The present disclosure relates to a support device for facilitating the loading of a container on a vehicle.

### BACKGROUND

When loading a container on to a vehicle, it is often necessary to slidably support the underside of a container, where, by providing a support over a sufficient length, damage to the container can be avoided. Such support arrangements are often configured to pivot with respect to the vehicle so that they can accommodate the changing attitude of the container during the loading operation as the container becomes horizontal.

Some support arrangements are also configured to be collapsible in order to reduce the overall length of the vehicle when not in use, and to move them out of the way when loading alternate cargo such as flat racks, which can require alternative support arrangements or which are not correctly aligned with the vehicle.

Such arrangements are typically manually operated by one or more people, with collapsible components moved into position and then locked in place using pins or other suitable temporary locking arrangements.

Other solutions are also known to use hydraulic actuators to move collapsible components between stowed and deployed positions, where resultant loads from loaded containers acting on the supports are transferred through the hydraulic components, which need to be suitably rated to be able to support these loads.

It is against this background that the present disclosure has been developed.

### SUMMARY

According to a first aspect, there is provided a support device for facilitating the loading of a container on a vehicle, the support device comprising a front arm and a rear arm, comprising corresponding front and rear support surfaces for the container, the front and rear arms being pivotally connected to one another about a first axis, and pivotally moveable relative to one another between a stowed configuration and a deployed configuration, wherein pivotal movement of the front and rear arms relative to one another is achieved by way of an actuator acting on intermediate portions of both the front and rear arms, where from a stowed configuration, extension of the actuator moves the front and rear arms toward their deployed configuration, and where from the deployed configuration, retraction of the actuator moves the front and rear arms toward their stowed configuration, the support device further comprising a latching arrangement for securing the front and rear arms in their deployed configuration.

In one form, the latching arrangement comprises a latch pin secured with respect to the front arm and a hook pivotally connected with respect to the rear arm, the hook comprising a first end configured to engage with the latch pin when the front and rear arms are in their deployed configuration.

In one form, the hook is configured to be moved by the actuator, where, from the deployed configuration, further extension of the actuator results in the first end of the hook being driven into an engaging position with the latch pin.

In one form, the support device further comprises a linkage, which is pivotally connected with respect to the actuator and a second end of the hook, wherein once the hook has been driven into the engaging position, the actuator, linkage and hook form an over centre arrangement where the hook can only be disengaged from the latch pin by retraction of the actuator.

In one form, the actuator is in the form of a hydraulic cylinder.

In one form, the support device is configured to be pivotally mounted relative to the vehicle.

In one form, the support device further comprises front and rear control surfaces configured to limit movement of the front and rear arms with respect to the vehicle.

In one form, the front control surface is fixed with respect to the vehicle and is configured to prevent forward rotation of the front arm beyond a nominal stowed position.

In one form, the rear control surface is fixed with respect to the vehicle and configured to control rotation of the rear arm with respect to the vehicle.

In one form, when in the stowed configuration, a portion of the front arm bears against the front control surface and a portion of the rear arm bears against the rear control surface.

In one form, when in the deployed configuration, ready for receiving a container, a portion of the rear arm bears against the rear control surface by virtue of the self-weight of the support device.

In one form, when in the deployed configuration, having loaded a container, the support device rotates with respect to the vehicle, such that the rear arm rotates away from the rear control surface.

According to a second aspect there is provided a support arrangement for facilitating the loading of a container on a vehicle, the support arrangement comprising a pair of support devices as described above, which are symmetrically mounted with respect to the vehicle so that there is one support device on each side of the vehicle, at the rear of the vehicle, and which are adapted to serve as sliding supports for the container.

### BRIEF DESCRIPTION OF DRAWINGS

Embodiments of the present invention will be discussed with reference to the accompanying drawings wherein:

FIG. 1 is a rear perspective view of a portion of a vehicle comprising a load handling system, according to an embodiment;

FIG. 2 is a left side view of the vehicle and load handling system of FIG. 1, alongside a container;

FIG. 3 is a left side view of the vehicle and load handling system of FIG. 1, showing a container in a first partially loaded state;

FIG. 4 is a left side view of the vehicle and load handling system of FIG. 1, showing a container in a second partially loaded state;

FIG. 5 is a left side view of the vehicle and load handling system of FIG. 1, showing a container in a third partially loaded state;

FIG. 6 is a left side view of the vehicle and load handling system of FIG. 1, showing a container in a fourth partially loaded state;

FIG. 7 is a left side view of the vehicle and load handling system of FIG. 1, showing a container in a fully loaded state;

FIG. 8 is a left side view of a support device, according to an embodiment;

FIG. 9 is a right side view of the support device of FIG. 8;

FIG. 10 is a rear perspective view of the support device of FIG. 8;

FIG. 11 is a top perspective view of the support device of FIG. 8;

FIG. 12 is a front perspective view of the support device of FIG. 8;

FIG. 13 is a left side view of the support device of FIG. 8, with a portion of the rear arm removed to reveal the inner workings of a latching arrangement;

FIG. 14 is a left side view of the support device of FIG. 8, in a first intermediate extension configuration;

FIG. 15 is a right side view of the support device of FIG. 8, in a first intermediate extension configuration;

FIG. 16 is a rear perspective view of the support device of FIG. 8, in a first intermediate extension configuration;

FIG. 17 is a left side view of the support device of FIG. 8, in a second intermediate extension configuration;

FIG. 18 is a right side view of the support device of FIG. 8, in a second intermediate extension configuration;

FIG. 19 is a rear perspective view of the support device of FIG. 8, in a second intermediate extension configuration;

FIG. 20 is a left side view of the support device of FIG. 8, in a third intermediate extension configuration;

FIG. 21 is a right side view of the support device of FIG. 8, in a third intermediate extension configuration;

FIG. 22 is a rear perspective view of the support device of FIG. 8, in a third intermediate extension configuration;

FIG. 23 is a left side view of the support device of FIG. 8, in a fully extended configuration;

FIG. 24 is a right side view of the support device of FIG. 8, in a fully extended configuration;

FIG. 25 is a rear perspective view of the support device of FIG. 8, in a fully extended configuration;

FIG. 26 is a left side view of the support device of FIG. 8, in a fully extended configuration, with portions of the front and rear arms removed to reveal the inner workings of the latching arrangement;

FIG. 27 is a left side view of the support device of FIG. 8, in a fully deployed configuration, with portions of the front and rear arms removed to reveal the inner workings of the latching arrangement;

FIG. 28 is a left side view of the support device of FIG. 8, in a fully loaded configuration;

FIG. 29 is a right side view of the support device of FIG. 8, in a fully loaded configuration; and

FIG. 30 is a rear perspective view of the support device of FIG. 8, in a fully loaded configuration.

### DESCRIPTION OF EMBODIMENTS

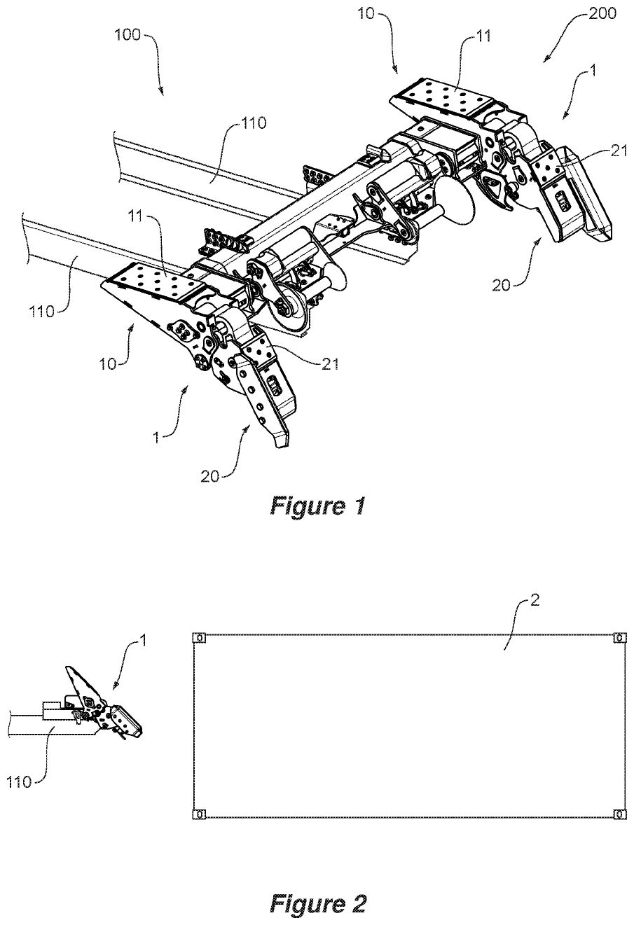

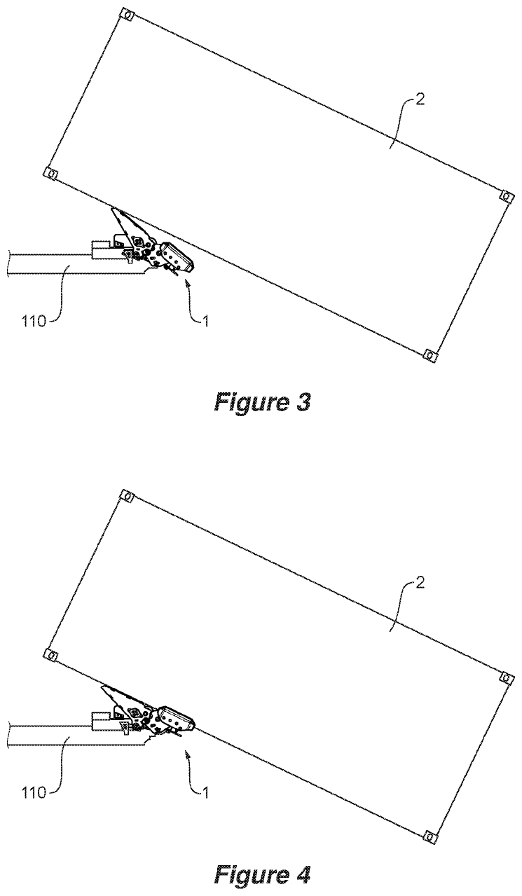

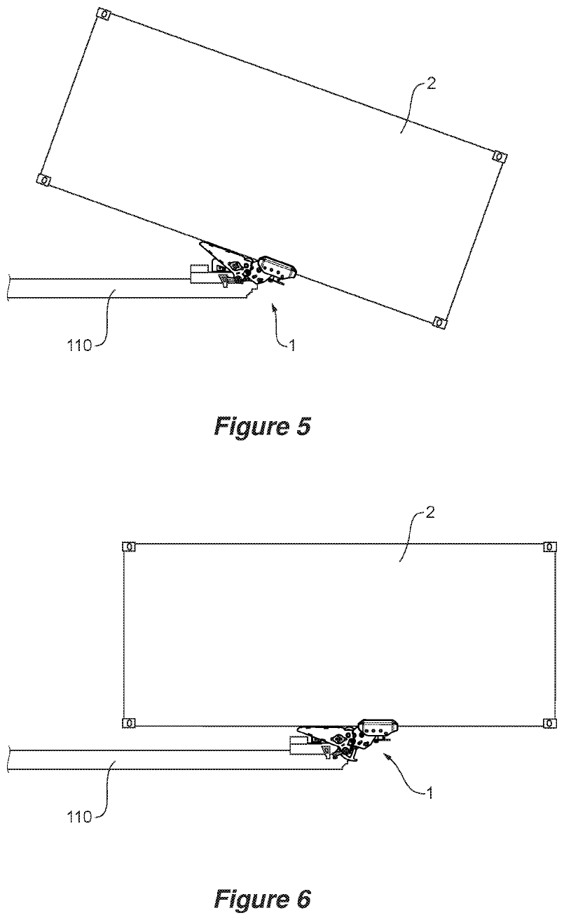

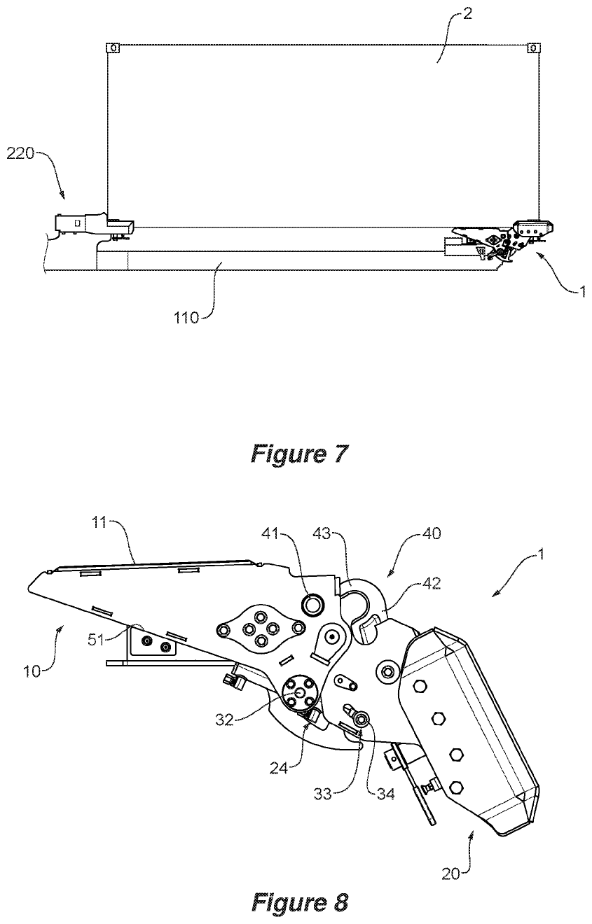

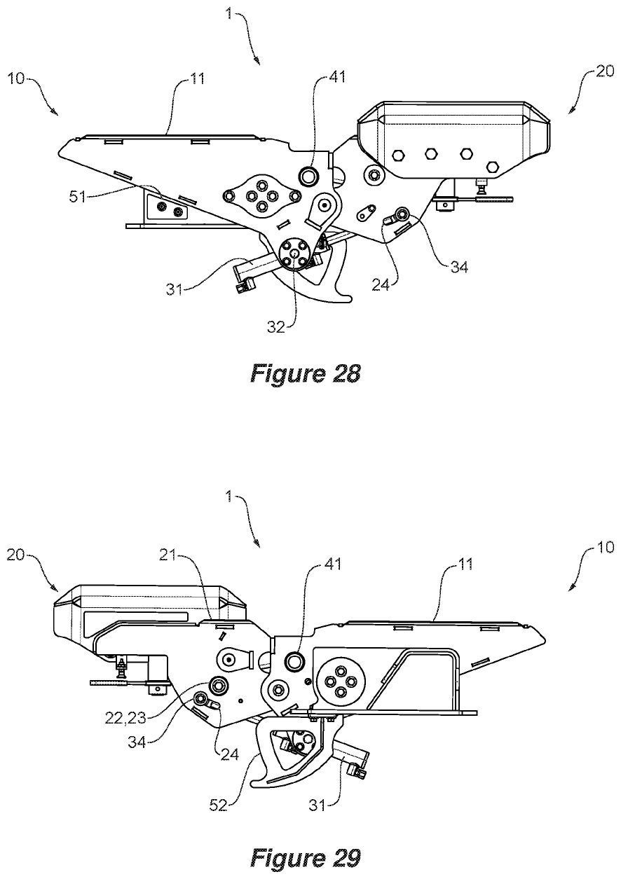

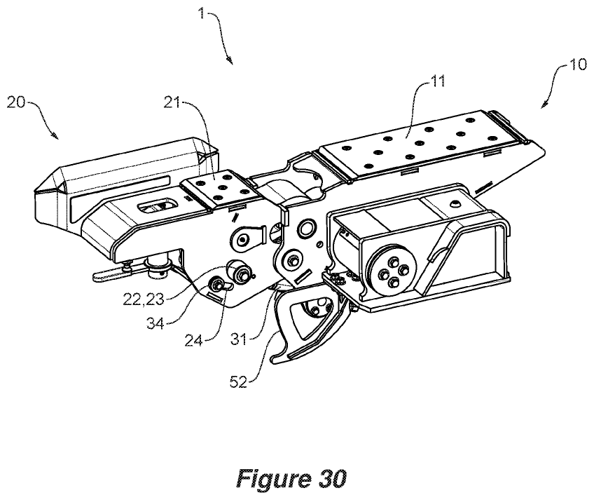

Referring to FIG. 1, where a portion of rear end of a vehicle 100 is shown, comprising a pair of chassis rails 110 for supporting a vehicle platform (not shown), and a load handling system 200 comprising a pair of support devices 1 symmetrically mounted at the rear of the vehicle 100 and adapted to serve as sliding supports to standardised ISO containers 2 as they are loaded on to the vehicle. With reference to FIGS. 2 to 7, where a series of views show the progressive loading of the container on to the vehicle, it can be seen that each support device 1 is pivotable with respect to the vehicle, about a horizontal and transverse axis, so as to occupy a substantially horizontal position (as shown in FIGS. 7 and 28 to 30), or an inclined working position with variable inclination (as shown in FIGS. 2 to 6) which allow the support devices to automatically accompany the tilting movement of the container during loading or unloading, where the underside of the container rests its lateral edges on the support devices 1, and where low friction support surfaces 11, 21 on each support device 1 allow the container to slide along the support devices 1. By virtue of the support devices 1 pivoting with respect to the vehicle, they accompany the tilting movement of the container as it rests on the low friction support surfaces.

While in the embodiment shown and described, the support device 1 comprises low friction support surfaces 11, 21, it will be appreciated that in an alternative embodiment the support device may instead comprise a plurality of rollers, also configured to slidably support the container.

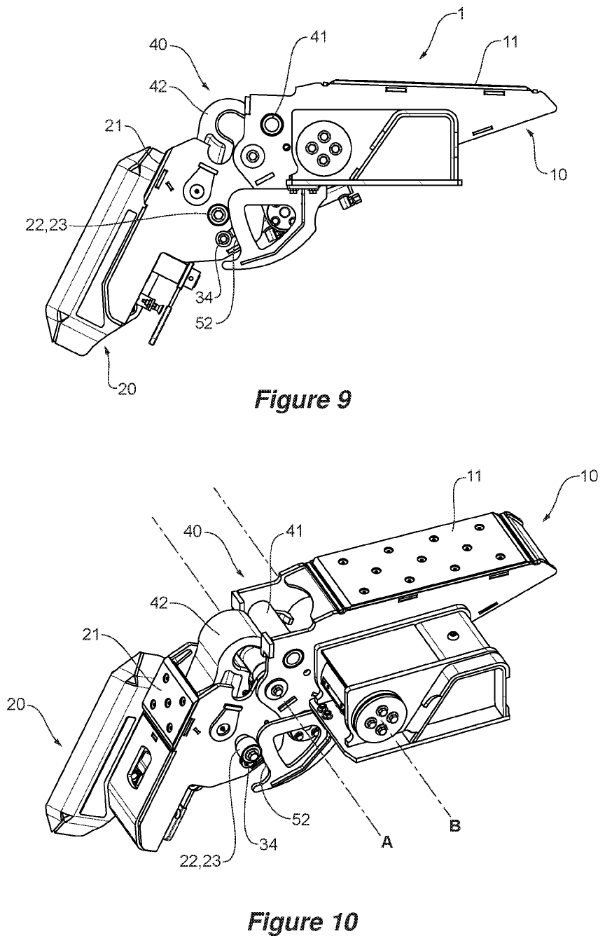

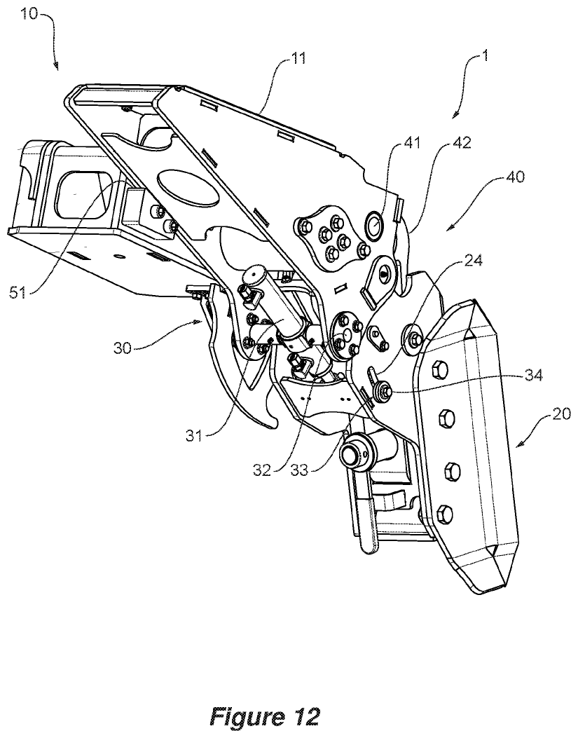

The support devices 1 are pivotally mounted relative to the vehicle and are configured to selectively occupy either a deployed configuration (as shown in FIGS. 27 to 30) adapted to support the container during loading or unloading operations, or a stowed configuration (as shown in FIGS. 8 to 13) adapted to move out of the way when the vehicle is loading alternate cargo, such as a flat rack.

In order to move between the two configurations, each support device 1 comprises a front arm 10 and a rear arm 20 pivotally connected to one another about a first axis A, with the front arm 10 pivotally connected with respect to the vehicle about a second axis B. The front and rear arms 10, 20 are provided with corresponding front and rear low friction support surfaces 11, 21 respectively. In the deployed configuration, the front and rear arms 10, 20 are moved to positions where the front and rear low friction support surfaces 11, 21 are substantially co-planar, such that a continual support is provided for the container. In the stowed configuration, the front and rear arms 10, 20 are moved to positions where an obtuse angle is formed between the arms 10, 20 and their support surfaces 11, 21, breaking the continuity of support, and moving the rear arm 20 away from a position where it would otherwise interfere with the loading of alternate cargo.

Pivotal movement of the front and rear arms 10, 20 relative to one another is achieved by means of an actuator 30 in the form of a hydraulic cylinder 31 acting on intermediate portions of both the front and rear arms 10, 20, where from a stowed configuration, extension of the hydraulic cylinder 31 moves the front and rear arms 10, 20 toward their fully extended, deployed configuration, and where from the deployed configuration, retraction of the hydraulic cylinder 31 moves the front and rear arms 10, 20 toward their fully retracted, stowed configuration.

The support device 1 further comprises front and rear control surfaces 51, 52, which limit movement of the arms 10, 20 with respect to the vehicle. The front control surface 51 is fixed with respect to the vehicle and is configured to prevent forward rotation of the front arm 10 beyond a nominal stowed position. The rear control surface 52 is fixed with respect to the vehicle and configured to control rotation of the rear arm 20 with respect to the vehicle. It will be appreciated that these control surfaces 51, 52 assist in movement of the arms 10, 20 between their stowed and deployed configurations, but also act as stops, providing forward and rearward rotation limits for the support device 1 when in its deployed configuration.

As best shown in FIGS. 8 to 13, when the hydraulic cylinder 31 is retracted such that the front and rear arms 10, 20 are in their stowed configurations, a portion of the front arm 10 bears against the front control surface 51 and a portion of the rear arm 20 bears against the rear control surface 52, where it will be appreciated that both control surfaces 51, 52 prevent any further retraction of the arms 10, 20.

When the hydraulic cylinder 31 is fully extended and the front and rear arms 10, 20 are in their deployed positions ready for receiving a container, a portion of the rear arm 20 bears against the rear control surface 52 by virtue of the self-weight of the support device 1. As best shown in FIGS. 7 and 28 to 30 which show the support device 1 after a container has been loaded, it can be seen that the support device 1 has rotated with respect to the vehicle, such that the rear arm 20 has rotated away from the rear control surface 52 and such that the rear arm 20 and front arm 10 are substantially horizontal.

It can be seen that the rear arm 20 is provided with a follower 22 configured to bear against the rear control surface 52. In the embodiment shown, the follower 22 is in the form of a roller 23 and is capable of rotating with respect to the rear arm 20, in order to reduce friction between the roller 23 and rear control surface 52 in circumstances where the roller 23 is bearing against the rear control surface 52. It will be appreciated that in an alternate embodiment, the follower 22 and/or the control surface 52 may instead feature low friction surfaces.

With reference to FIGS. 8, 12 and 13, it can be seen that a first end 32 of the hydraulic cylinder 31 is pivotally connected with respect to an intermediate portion of the front arm 10 and a second end 33 of the hydraulic cylinder 31 is slidably and pivotally connected with respect to the rear arm 20 by virtue of a pin 34 rotatably connected with respect to the second end 33 of the hydraulic cylinder 31, and which is slidably received by arcuate slots 24 formed in the rear arm 20, whose purpose will be described in further detail below.

The support device 1 also comprises a latching arrangement 40 for mechanically securing the front and rear arms 10, 20 in their deployed positions. It will be appreciated that by providing such an arrangement that resultant loads transferred through the support device 1 from the weight of the container are not borne by the hydraulic cylinder 31. It will be further appreciated that such an arrangement means that the hydraulic cylinder 31 that is used to move the front and rear arms 10, 20 does not have to remain energised to support the weight of the container, and therefore does not have to be rated to support the weight of the container, instead only having to be rated to move the arms 10, 20 between their stowed and deployed positions.

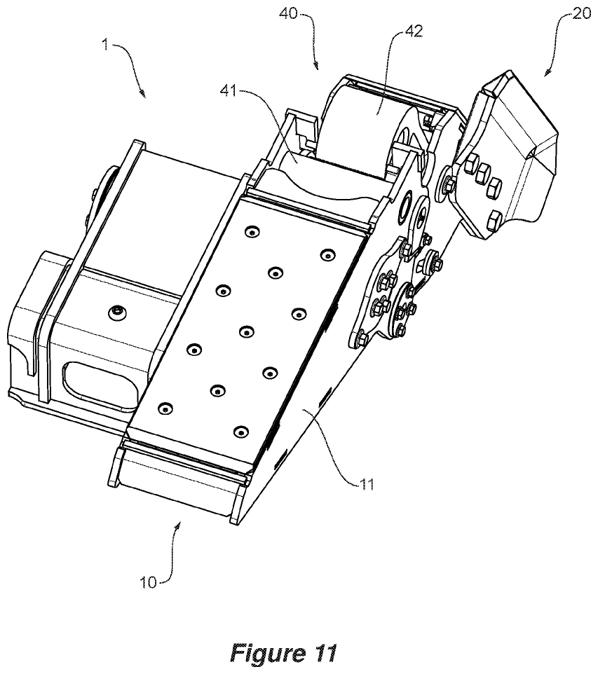

As best seen in FIGS. 10, 11 and 13, it can be seen that the latching arrangement 40 comprises a latch pin 41 rigidly secured with respect to the front arm 10, and a hook 42, pivotally connected with respect to the rear arm 20 and having a first end 43 configured to engage with the latch pin 41 when the front and rear arms 10, 20 are in their deployed positions.

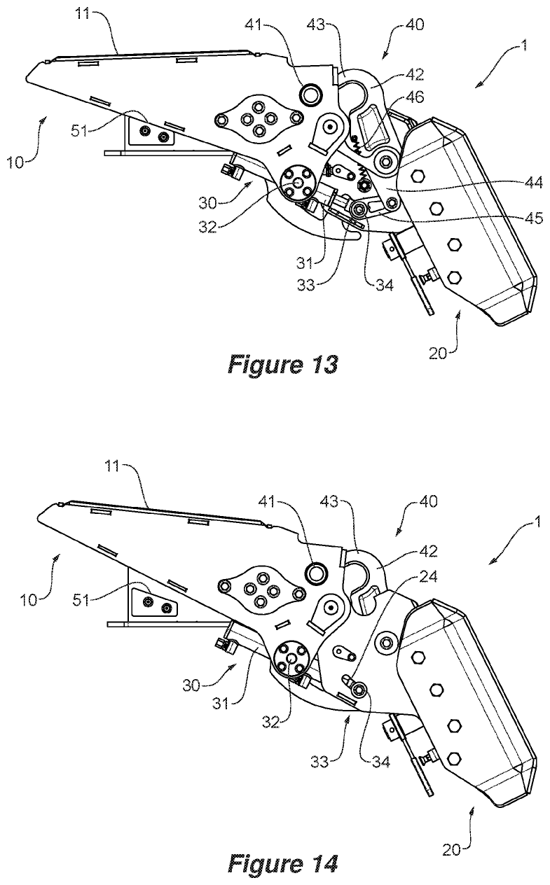

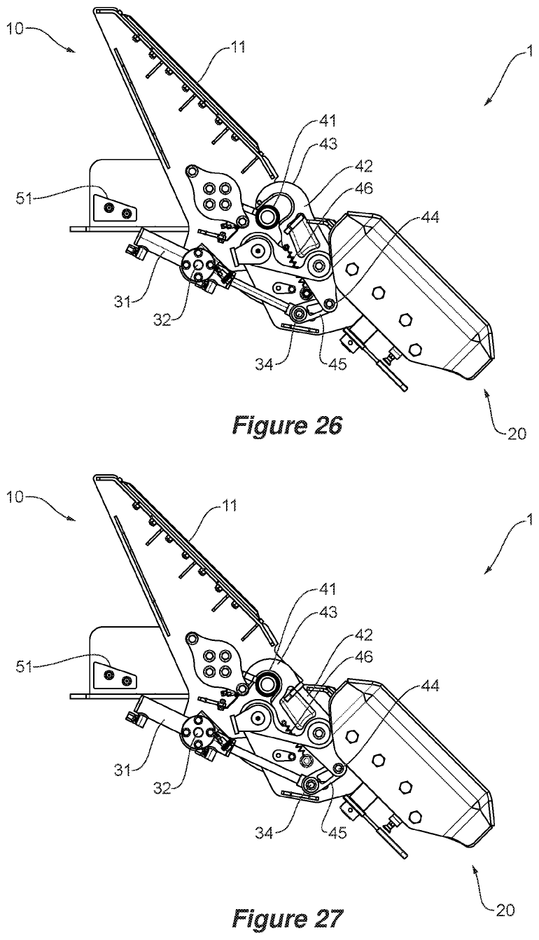

As best seen in FIGS. 13 and 26, the hook 42 is also actuated by the same hydraulic cylinder 31 that moves the front and rear arms 10, 20, where further extension of the hydraulic cylinder 31 (after the front and rear arms 10, 20 have reached their fully extended positions) results in the first end 43 of the hook 42 being driven into an engaging position with the latch pin 41.

As can also be seen in FIGS. 13 and 26, the hydraulic cylinder 31 is connected to the hook 42 by virtue of a linkage 45, which is pivotally connected with respect to the hydraulic cylinder 31 and a second end 44 of the hook 42. It can be seen that in the stowed configuration, the first end 43 of the hook 42 bears against, but is not able to engage with the latch pin 41. It will be appreciated that as the hydraulic cylinder extends, by virtue of the first end 43 of the hook 42 bearing against the latch pin 41 and the rear arm 20 bearing against the rear control surface 52, that the only remaining degree of freedom available is for the front arm 10 to rotate rearward away from the front control surface 51, with the angle between the arms 10, 20 increasing. As the hydraulic cylinder 31 continues to extend, the follower 22 travels down the rear control surface 52, with the front arm 10 continuing to move away from the front control surface 51. By virtue of the first end 53 of the hook 52 bearing against the latch pin 51, it can be seen that the position of the second end 33 of the hydraulic cylinder 31 with respect to the arcuate slots 24 varies. The follower 22 will continue to travel down the rear control surface 52 until it is prevented from travelling any further, and the forward arm 10 continues to rotate further rearward until it bears against the rear arm 20 in the fully extended position. As shown in FIG. 26, when the front and rear arms 10, 20 reach this fully extended position, the hook 42 (having moved with the rear arm 20 that it is pivotally connected to) has moved to a position (with respect to the latch pin 41) where its first end 43 may be driven to engage the latch pin 41. With the front and rear arms 10, 20 bearing against each other, the only remaining degree of freedom is for the hydraulic cylinder 31 to drive the hook 42 to engage the latch pin 41 (as best shown in FIG. 27) where the arcuate slots 24 guide the movement of the second end 44 of the hydraulic cylinder and the linkage 45.

Once latched, the hydraulic cylinder 31, linkage 45 and hook 42, form an “over centre” arrangement where the hook 42 can only be disengaged from the latch pin 41 by retracting the hydraulic cylinder 31. It will be appreciated that once the hook 42 is latched, the hydraulic cylinder 31 can be deactivated, and the front and rear arms 10, 20 will remain latched in their deployed positions.

The latching arrangement 40 also comprises a plurality of springs 46, biasing the first end 43 of the hook 42 toward the latch pin 41. It will be appreciated that these springs 46 prevent or at least reduce rattling of the hook 42 when the hydraulic cylinder 31 is deactivated, both when the device is in a stowed configuration and in a deployed configuration. With reference to FIG. 11 it can be seen that the hook 42 also comprises a pair of pins 47 that are configured to bear against complimentary stop surfaces 12 on the front arm 10 when the system is in a stowed configuration.

It will be appreciated that by providing a support device 1 with the above described latching arrangement 40, that the mechanical locking of the front and rear arms 10, 20 in their deployed configuration occurs as a natural and automatic extension of their actuation into position, without requiring a separate, or manual operation.

Movement of the support device 1 from its stowed configuration through to its fully deployed configuration will now be described.

As best shown in FIGS. 8 to 13, the support device 1 starts in its stowed configuration, with the hydraulic cylinder 31 retracted and the front and rear arms 10, 20 bearing against their respective front and rear control surfaces 51, 52.

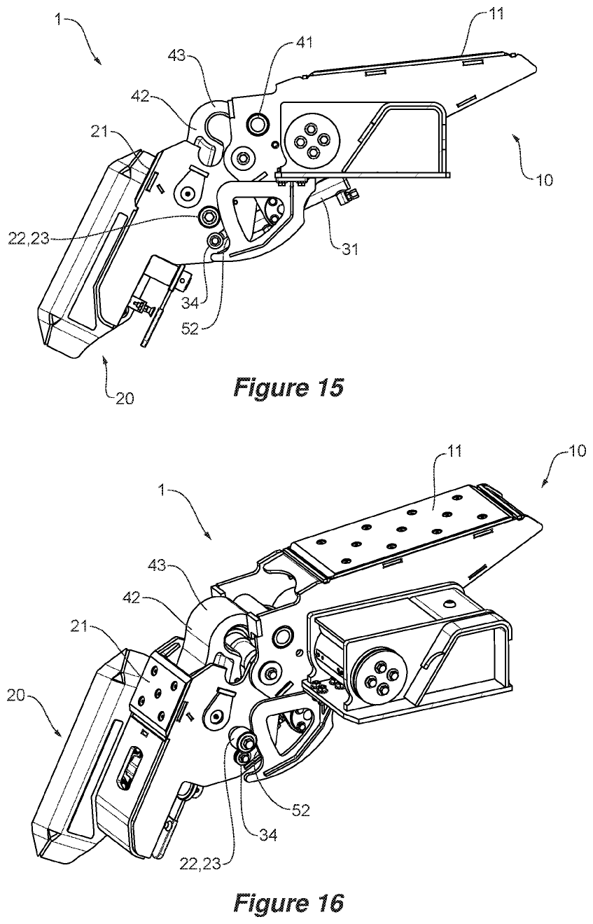

Referring now to FIGS. 14 to 16, where the support device 1 is shown in a first intermediate extension configuration, with the hydraulic cylinder 31 having partially extended, increasing the angle between the front and rear arms 10, 20. Due to the front arm 10 being pivotally connected with respect to the vehicle about axis B, and the self-weight of the support device 1, the follower 22 on the rear arm 20 continues to bear against the rear control surface 52, and the front arm 10 begins to rotate away from the front control surface 51.

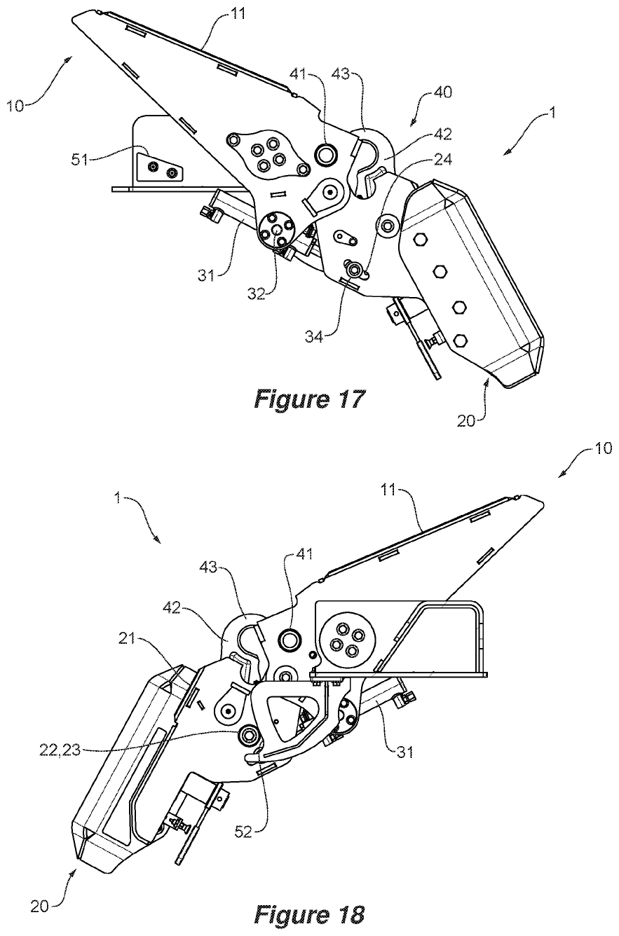

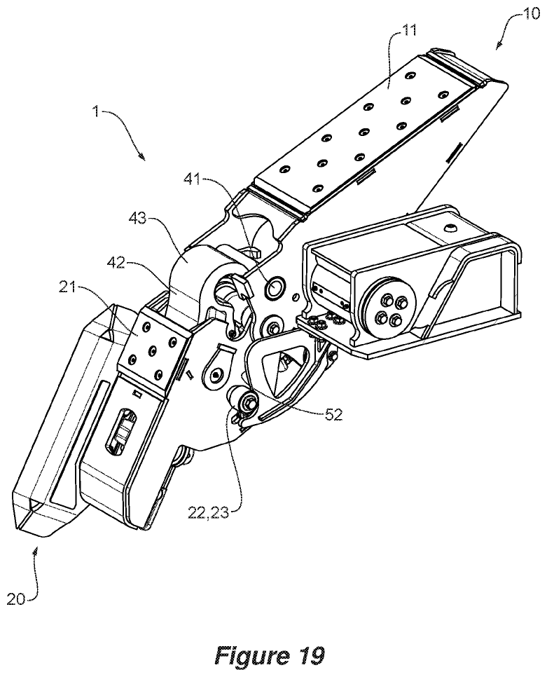

Referring now to FIGS. 17 to 19, where the support device 1 is shown in a second intermediate extension configuration, with the hydraulic cylinder 31 having extended further, increasing the angle between the front and rear arms 10, 20. It can be seen that the front arm 10 has rotated further away from the front control surface 51 and the follower 22 on the rear arm 20 has travelled further down the rear control surface 52.

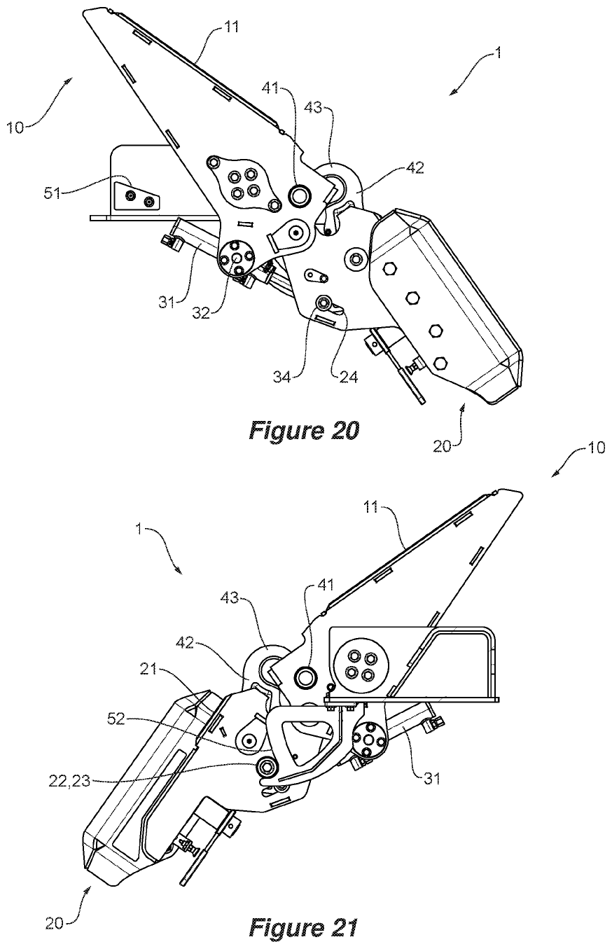

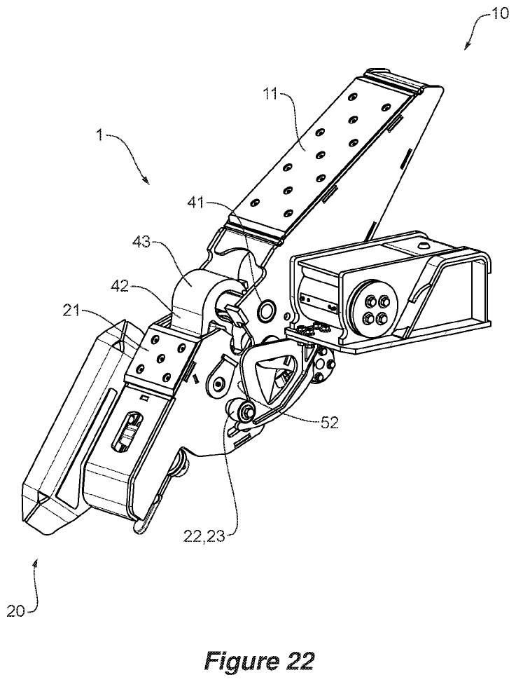

Referring now to FIGS. 20 to 22, where the support device 1 is shown in a third intermediate extension configuration, with the hydraulic cylinder 31 having extended further, increasing the angle between the front and rear arms 10, 20. It can be seen that the front arm 10 has rotated further away from the front control surface 51 and the rear arm 20 has travelled further down the rear control surface 52, where the follower 22 is now prevented from travelling any further. It will be appreciated that further extension of the hydraulic cylinder will cause the rear arm 20 to pivot forward about the follower 22 and the front arm 10 to pivot rearward with respect to the vehicle.

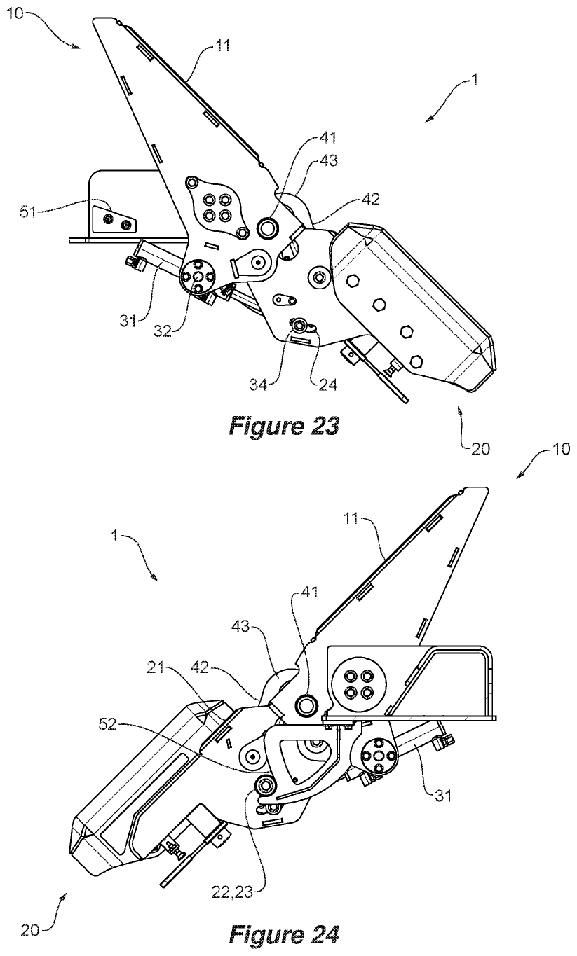

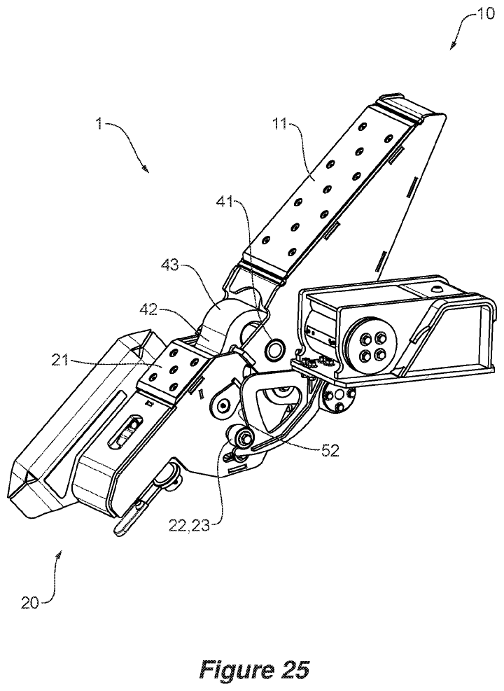

Referring now to FIGS. 23 to 26, where the support device 1 is shown in a fully extended configuration, with the hydraulic cylinder 31 having extended further, and where the front and rear arms 10, 20 are now bearing against each other. As best shown in FIG. 26, the first end 43 of the hook 42 has moved to a position where it may be driven to engage the latch pin 41.

Referring now to FIG. 27, it can be seen that the hydraulic cylinder 31 has been driven to engage the latch pin 41, with the hydraulic cylinder 31, linkage 45, and hook 42, forming an “over centre” arrangement where the hook 42 can only be disengaged from the latch pin 41 by retracting the hydraulic cylinder 31. In this position, the support device 1 is in its fully deployed configuration, and ready to receive a container. It will be appreciated that the only remaining degree of freedom is for the entire support device 1 to rotate with respect to the vehicle around axis B during loading/unloading of the container, with the front and rear control surfaces 51, 52 limiting the range of motion of the support device 1.

Referring now to FIGS. 7 and 28 to 30 where the support device 1 is shown in a loaded configuration, after a container has been loaded on to the vehicle such that the front of the container 2 rests upon a pair of front supports 220 and the rear of the container rests on a pair of the support devices 1. It can be seen that the support device 1 has rotated forward such that the front arm 10 is in a substantially horizontal position, with a small gap formed between the front arm 10 and the front control surface 51 and the rear arm 20 has rotated away from the rear control surface 52. It will be appreciated that this small gap is achieved by virtue of the front control surface 51 being a few degrees past horizontal, the purpose of the gap being to allow movement as the vehicle travels over bumps rather than transferring the load of the container through the front control surface 51. It will be appreciated that the support device 1 is held in this configuration due to the fact that the container is supported at its front end. In the event that the container does jump off the support device when travelling over a bump, the front control surface would act to limit the extent to which the support device 1 could possibly rotate.

While a latching arrangement comprising a latch pin and actuator driven hook is shown and described, it will be appreciated that alternative latching arrangements that are driven by the actuator once the front and rear arms are in their deployed positions are also intended to fall within the scope of this disclosure. For instance, in an alternative embodiment, the actuator may drive one or more shear pins from a stowed position to an engaged position, where the shear pins interact with both the front and rear arms to prevent relative rotation.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A support device for facilitating the loading of a container on a vehicle, the support device comprising a front arm and a rear arm, comprising corresponding front and rear support surfaces for the container, the front and rear arms being pivotally connected to one another about a first axis, and pivotally moveable relative to one another between a stowed configuration and a deployed configuration, wherein pivotal movement of the front and rear arms relative to one another is achieved by way of an actuator acting on intermediate portions of both the front and rear arms, where from a stowed configuration, extension of the actuator moves the front and rear arms toward their deployed configuration, and where from the deployed configuration, retraction of the actuator moves the front and rear arms toward their stowed configuration, the support device further comprising a latching arrangement for securing the front and rear arms in their deployed configuration.

2. The support device as claimed in claim 1, wherein the latching arrangement comprises a latch pin secured with respect to the front arm and a hook pivotally connected with respect to the rear arm, the hook comprising a first end configured to engage with the latch pin when the front and rear arms are in their deployed configuration.

3. The support device as claimed in claim 2, wherein the hook is configured to be moved by the actuator, where, from the deployed configuration, further extension of the actuator results in the first end of the hook being driven into an engaging position with the latch pin.

4. The support device as claimed in claim 3, further comprising a linkage, which is pivotally connected with respect to the actuator and a second end of the hook, wherein once the hook has been driven into the engaging position, the actuator, linkage and hook form an over centre arrangement where the hook can only be disengaged from the latch pin by retraction of the actuator.

5. The support device as claimed in claim 1, wherein the actuator is in the form of a hydraulic cylinder.

6. The support device as claimed in claim 1, wherein the support device is configured to be pivotally mounted relative to the vehicle.

7. The support device as claimed claim 1, further comprising front and rear control surfaces configured to limit movement of the front and rear arms with respect to the vehicle.

8. The support device as claimed in claim 7, wherein the front control surface is fixed with respect to the vehicle and is configured to prevent forward rotation of the front arm beyond a nominal stowed position.

9. The support device as claimed in claim 7, wherein the rear control surface is fixed with respect to the vehicle and configured to control rotation of the rear arm with respect to the vehicle.

10. The support device as claimed in claim 7, wherein, when in the stowed configuration, a portion of the front arm bears against the front control surface and a portion of the rear arm bears against the rear control surface.

11. The support device as claimed in any one of claims 7 to 10 claim 7, wherein, when in the deployed configuration, ready for receiving a container, a portion of the rear arm bears against the rear control surface by virtue of the self-weight of the support device.

12. The support device as claimed in claim 7, wherein, when in the deployed configuration, having loaded a container, the support device rotates with respect to the vehicle, such that the rear arm rotates away from the rear control surface.

13. A support arrangement for facilitating the loading of a container on a vehicle, the support arrangement comprising a pair of support devices as claimed in claim 1, which are symmetrically mounted with respect to the vehicle so that there is one support device on each side of the vehicle, at the rear of the vehicle, and which are adapted to serve as sliding supports for the container.
